(19) United States
(12) Patent Application Publication
(10) Pub. No.: US 2012/0019746 A1
(43) Pub. Date: Jan. 26, 2012

(54) DISPLAY DEVICE AND METHOD FOR MANUFACTURING THE SAME

(75) Inventor: Takayuki Yamada, Osaka (JP)

(73) Assignee: SHARP KABUSHIKI KAISHA, Osaka-shi, Osaka (JP)

(21) Appl. No.: 13/258,322

(22) PCT Filed: Dec. 7, 2009
(86) PCT No.: PCT/JP2009/070480

§ 371 Date: Sep. 21, 2011

(30) Foreign Application Priority Data
Apr. 7, 2009 (JP) 2009-093126

(51) Int. Cl. G02F 1/1335; B32B 37/14; B32B 37/12

(52) U.S. Cl. 349/96; 156/60; 156/285

(57) ABSTRACT

A liquid crystal display device (1) includes a protective plate (11), a double-sided tape (13a) that serves as an adhesive layer, a polarizing plate (15b₁), and a liquid crystal substrate. The outer edge of the double-sided tape (13a) is located inside the outer edge of the polarizing plate (15b₁). When affected by the temperature, humidity or the like, the polarizing plate (15b₁) shrinks in the h₁ direction. However, the double-sided tape (13a) is not affected by the shrinkage of the polarizing plate (15b₁) and thus no air bubbles are formed therein, since a burr portion (21) of the polarizing plate (15b₁) is not covered with the double-sided tape (13a). Moreover, even when the polarizing plate (15b₁) swells in the h₂ direction, the double-sided tape (13a) is not affected by the swelling. In other words, the influence of shrinkage/swelling of the polarizing plate (15b₁) on the double-sided tape (13a) can be reduced by configuring the double-sided tape (13a) to have such a small size not to cover the burr portion (21) of the polarizing plate (15b₁).

### TECHNICAL FIELD

The present invention relates to a display device including a translucent member and a method for manufacturing the same.

### BACKGROUND ART

In the art of relatively small liquid crystal display devices used for products such as mobile phones and PDA, a structure with no air gap between a liquid crystal panel and a protective plate forming the surface of the product has been employed for the purpose of improving the visibility of the liquid crystal screen. FIG. 1A shows a conventional structure with an air gap 10 between a protective plate 11 and a liquid crystal panel 15. FIG. 1B shows a structure from which the air gap 10 between the protective plate 11 and the liquid crystal panel 15 has been removed.

In FIG. 1A, since the air gap 10 has a refractive index different from the refractive indices of the protective plate 11 and the liquid crystal panel 15, light reflections a1-a6 are caused on the surfaces of the protective plate 11 and the liquid crystal panel 15 at the time the light passes therethrough. Due to the reflection caused by the air gap 10, light amount of the backlight 3 is reduced in a transmission type liquid crystal, while reflection due to external light 5 is increased in a reflection type liquid crystal. Such a reflection has caused degradation in the visibility of a liquid crystal screen, especially in an outdoor use.

To cope with this problem, the structure of FIG. 1B from which the air gap 10 has been removed is employed to suppress the reflections (a3 and a6) generated on the air gap 10, thereby reducing the reflections generated between the protective plate 11 and the liquid crystal panel 15 to the levels of b1-b4 so as to improve the visibility.

Further in FIG. 1B, the protective plate 11 and the liquid crystal panel 15 are attached to each other through an adhesive layer (not shown). Specifically, the protective plate 11 is attached to a polarizing plate (not shown) on the liquid crystal panel 15.

Regarding a case of attaching a display liquid crystal panel and a switching liquid crystal panel, a liquid crystal display device with an adhesive layer formed to cover entirely the outer edge of the polarizing plate has been known (see Patent document 1 for example).

### PRIOR ART DOCUMENT

### Patent Documents

Patent document 1: JP 2006-11212

### DISCLOSURE OF INVENTION

### Problem to be Solved by the Invention

FIG. 10 shows an example of a liquid crystal display device 1 provided with a protective plate 11. A liquid crystal panel 15 is configured by laminating respectively a polarizing plate 15b₂, a liquid crystal substrate 15a and a polarizing plate 15b₁. The polarizing plate 15b₁ of the liquid crystal panel 15 is adhered to the protective plate 11 through an adhesive layer 13. For the adhesive layer 13, for example, a double-sided tape, an ultraviolet curing type resin or the like is used.

In FIG. 10, the protective plate 11, the adhesive layer 13 and the polarizing plate 15b₁ are configured to have peripheral sizes decreased in this order. In a case of using a double-sided tape for the adhesive layer 13, it is required to adhere reliably the protective plate 11 and the whole surfaces of the double-sided tape. Therefore, after attaching the double-sided tape to the protective plate 11, the polarizing plate 15b₁ is attached to the double-sided tape, thereby the liquid crystal display device 1 is manufactured. In this case, the adhesive layer 13 is configured to have a periphery larger than that of the polarizing plate 15b₁.

However, when the structure as shown in FIG. 10 is employed, the polarizing plate swells and/or shrinks under the influence of temperature, humidity or the like, and it may cause generation of air bubbles between the adhesive layer 13 and the polarizing plate. In this case, the air bubbles can be recognized visually from the protective plate 11 side, and thus the quality and durability of the liquid crystal display device 1 are degraded.

A process where the air bubbles are generated will be described below with reference to FIGS. 11A, 11B and 11C. FIGS. 11A, 11B and 11C all are magnified cross-sectional views showing the right end portion of the liquid crystal display device 1 shown in FIG. 10.

In FIG. 11A, any air bubbles have not been generated yet. At the end portion of the polarizing plate 15b₁, a burr portion 21 that was formed at the time of cutting is present. And the upper face of the burr portion 21 is covered with the adhesive layer 13.

Typically, a polarizing plate is made of a PVA film or the like, which is dyed with an organic dye such as iodine and subsequently stretched in the axial direction. As a result, internal stress remains in the polarizing plate, and thus, if the polarizing plate is affected by heat or the like, swelling and/or shrinkage occurs easily.

For example in FIG. 11B, when the polarizing plate 15b₁ shrinks in the h₁ direction, air bubbles 31 are generated between the adhesive layer 13 and the polarizing plate 15b₁. Subsequently, when the polarizing plate 15b₁ swells in the h₂ direction in FIG. 11C, the air bubbles 31 become larger to be recognized visually from the v1 direction through the protective plate 11. Such generation of air bubbles is not favorable since it will cause degradation in quality and durability of the liquid crystal display device 1.

Therefore, with the foregoing in mind, it is an object of the present invention to provide a display device that is affected rarely by swelling and/or shrinkage of a polarizing plate.

### Means for Solving Problem

For achieving the above described object, a display device disclosed below is a display device including a display panel with a polarizing plate and a translucent member to be adhered to the polarizing plate through an adhesive layer, which is characterized in that at least a part of an end portion of the adhesive layer is located inside the outer edge of the polarizing plate. Since the end portion of the adhesive layer is located inside the outer edge of the polarizing plate, the display device can reduce the risk that the adhesive layer is affected by swelling and/or shrinkage of the polarizing plate.

### Effects of the Invention

As mentioned above, the display device of the present invention is effective as it is affected rarely by swelling and/or shrinkage of the polarizing plate.

### BRIEF DESCRIPTION OF DRAWINGS

FIG. 1A is a diagram showing an example of a structure where an air gap exists between a protective plate and a liquid crystal panel. FIG. 1B is a diagram showing an example of a structure where an air gap between the protective plate and the liquid crystal panel has been removed.

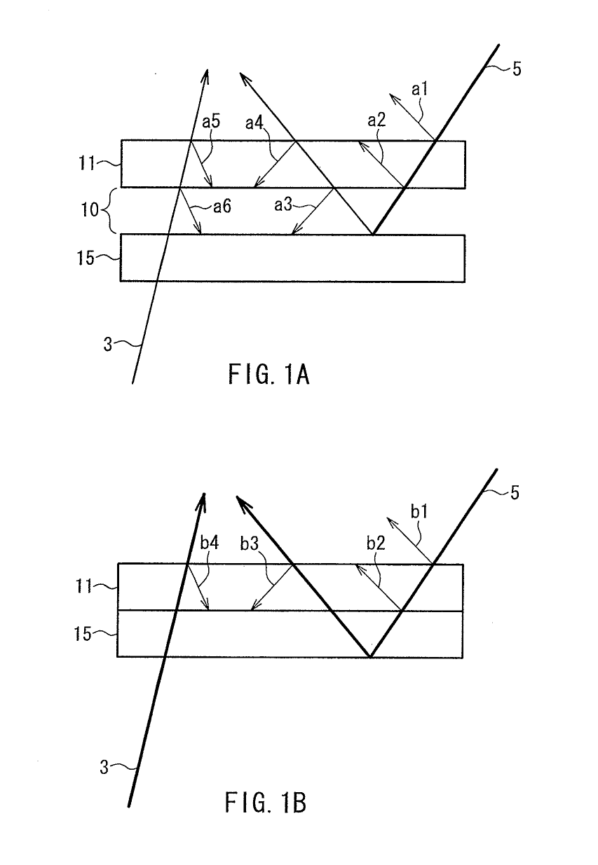

FIG. 2 is a side view showing an example of a liquid crystal display device.

FIG. 3 includes cross-sectional views showing an example of a process where a polarizing plate swells and shrinks in a liquid crystal display device.

FIG. 4 includes plan views showing an example of a liquid crystal display device.

FIG. 5 includes schematic diagrams showing an example of a method for manufacturing a liquid crystal display device.

FIG. 6 is a side view showing an example of a liquid crystal display device.

FIG. 7 includes schematic diagrams showing an example of a method for manufacturing a liquid crystal display device.

FIG. 8 includes schematic diagrams showing an example of a method for manufacturing a liquid crystal display device.

FIG. 9 is a side view showing an example of a liquid crystal display device.

FIG. 10 is a side view showing an example of a liquid crystal display device.

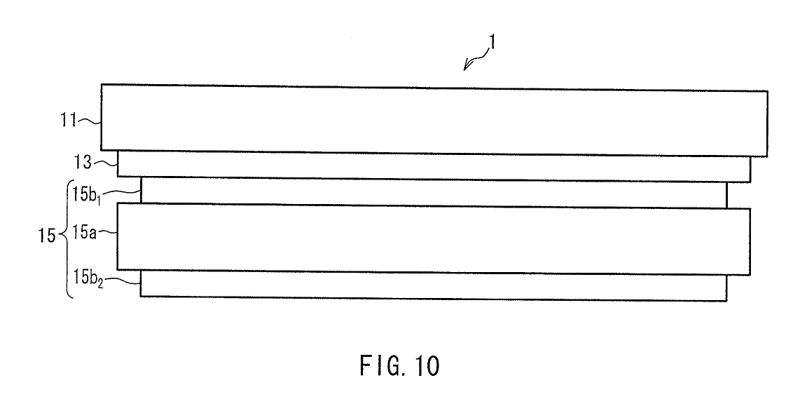

FIG. 11 includes cross-sectional views showing an example of a process where air bubbles are generated in a liquid crystal display device.

### DESCRIPTION OF THE INVENTION

(1) A liquid crystal display device according to an embodiment of the present invention is characterized in that it includes a display panel having a polarizing plate; and a translucent member adhered to the polarizing plate through an adhesive layer, where the adhesive layer is arranged so that at least a part of an end portion of the adhesive layer is located inside the outer edge of the polarizing plate. Thereby, the risk that the adhesive layer is affected by swelling and/or shrinkage of the polarizing plate can be reduced.

(2) In the display device, the adhesive layer may be arranged so that the end portion is located inside the outer edge of the polarizing plate in the polarizing axis direction of the polarizing plate. In this case, in the direction the polarizing plate will swell/shrink easily, influences on the adhesive layer can be reduced.

(3) In the display device, the adhesive layer may be formed of a double-sided tape. In this case, in a display device using a double-sided tape for adhesion between the translucent member and the polarizing plate, influences on the double-sided tape can be reduced.

(4) In the display device, the adhesive layer may be formed of an adhesive bond. In this case, in a display device using an adhesive bond for adhesion between the translucent member and the polarizing plate, influences on the adhesive bond can be reduced.

(5) A method for manufacturing a display device according to an embodiment of the present invention is a method for manufacturing a display device including a display panel having a polarizing plate and a translucent member adhered to the polarizing plate through an adhesive layer. The method includes: a first step of forming the adhesive layer on the polarizing plate so that at least a part of an end portion of the adhesive layer is located inside the outer edge of the polarizing plate; and a second step of bringing the translucent member through the adhesive layer into intimate contact with the polarizing plate on which the adhesive layer has been formed in the first step. Thereby, a display device with a lower risk of influence to be imposed on the adhesive layer by swelling and/or shrinkage of the polarizing plate can be manufactured with a high degree of accuracy.

(6) In the method for manufacturing a display device, the first step may be performed to form the adhesive layer so that the end portion of the adhesive layer is located inside the outer edge of the polarizing plate in the polarizing axis direction of the polarizing plate. In this case, it is possible to reduce influences on the adhesive layer in a direction the polarizing plate will swell and/or shrink easily.

(7) In the method for manufacturing a display device, the first step may be performed under an atmospheric pressure environment and the second step is performed under a vacuum environment. In this case, it is possible to attach reliably the polarizing plate and the adhesive layer, and the transparent member and the adhesive layer.

Hereinafter, preferable embodiments for the display device of the present invention will be described with reference to the attached drawings. In the explanation below, a case where the present invention is applied to a liquid crystal display device is illustrated.

### 1. First Embodiment

[1-1. Structure of a Liquid Crystal Display Device]

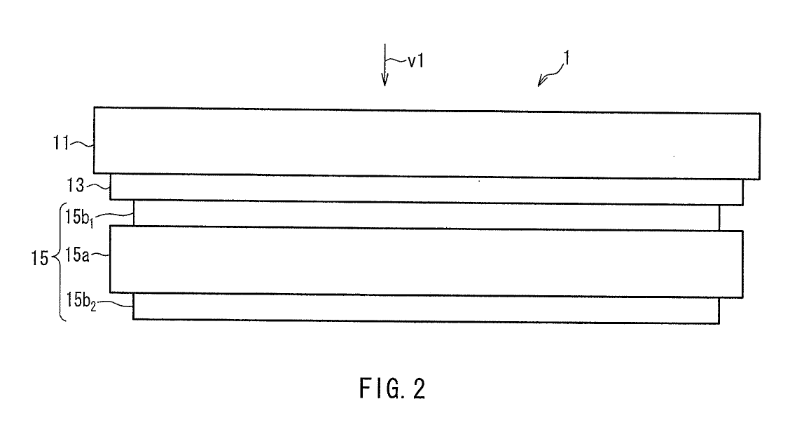

FIG. 2 is a side view showing a schematic structure of a liquid crystal display device 1 according to the present invention. This liquid crystal display device 1 includes a protective plate 11 as an example of translucent member, a double-sided tape 13a as an example of adhesive layer, a polarizing plate 15b₁, a liquid crystal substrate 15a and a polarizing plate 15b₂. The liquid crystal substrate 15a is formed of a glass substrate, a transparent electrode, an oriented film, a liquid crystal layer, a color filter and the like.

The polarizing plate 15b₁ and the polarizing plate 15b₂ are provided on the upper face and the lower face of the liquid crystal substrate 15a respectively. The polarizing plate 15b₁ and the protective plate 11 are adhered to each other by the double-sided tape 13a. Thereby, the structure does not have any air gap of different refractive index between the protective plate 11 and the polarizing plate 15b₁, and thus the visibility of the liquid crystal display device 1 is improved. A structure that has no air gap between a protective plate and a polarizing plate is called sometimes an AGL (Air Gap Less) structure. In FIG. 2, the double-sided tape 13a is attached to the polarizing plate 15b₁ so that an end portion 421 of the double-sided tape 13a is located inside an outer edge 401 of the polarizing plate 15b₁.

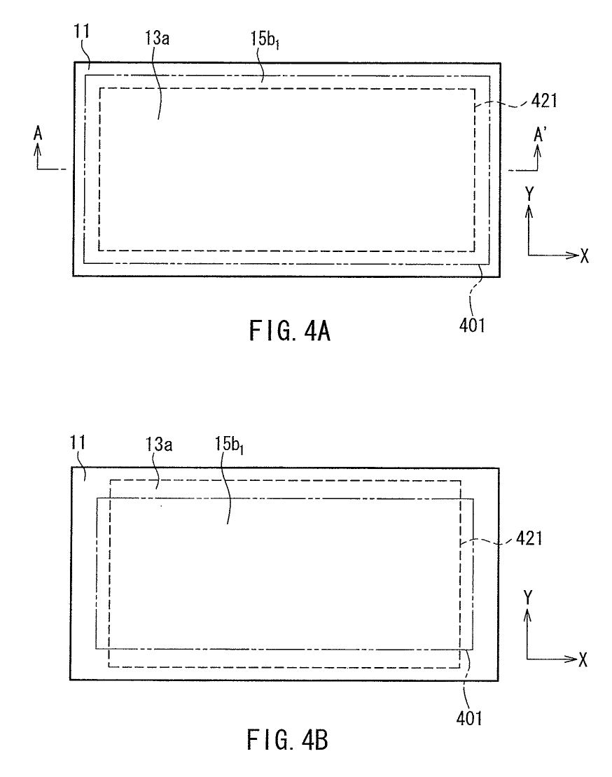

FIG. 4A is a plan view taken from the v1 direction indicated in FIG. 2. The end portion 421 of the double-sided tape 13a corresponds to the edge of the double-sided tape 13 on a plane perpendicular to the v1 direction. The outer edge 401 of the polarizing plate 15b₁ corresponds to the edge of the polarizing plate 15b₁ on a plane perpendicular to the v1 direction.

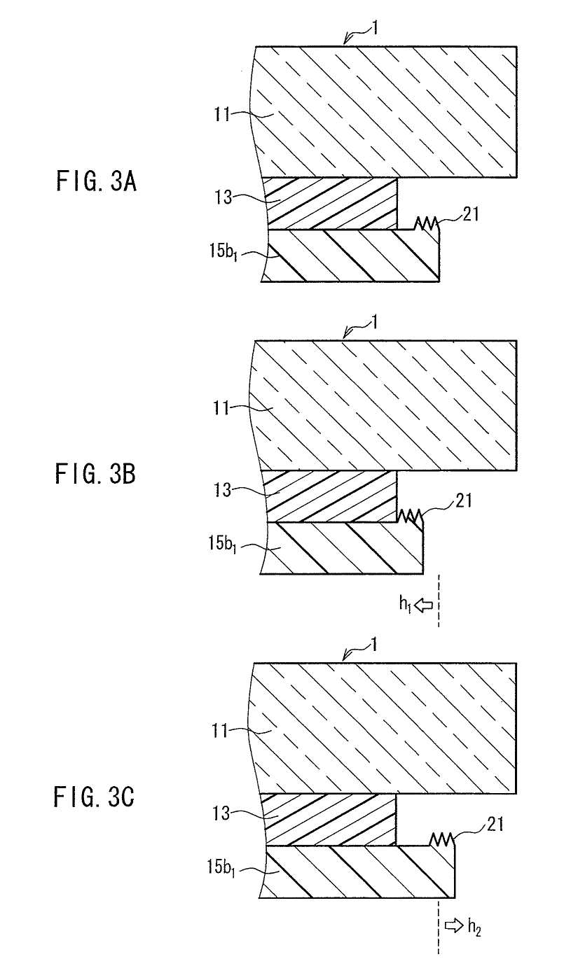

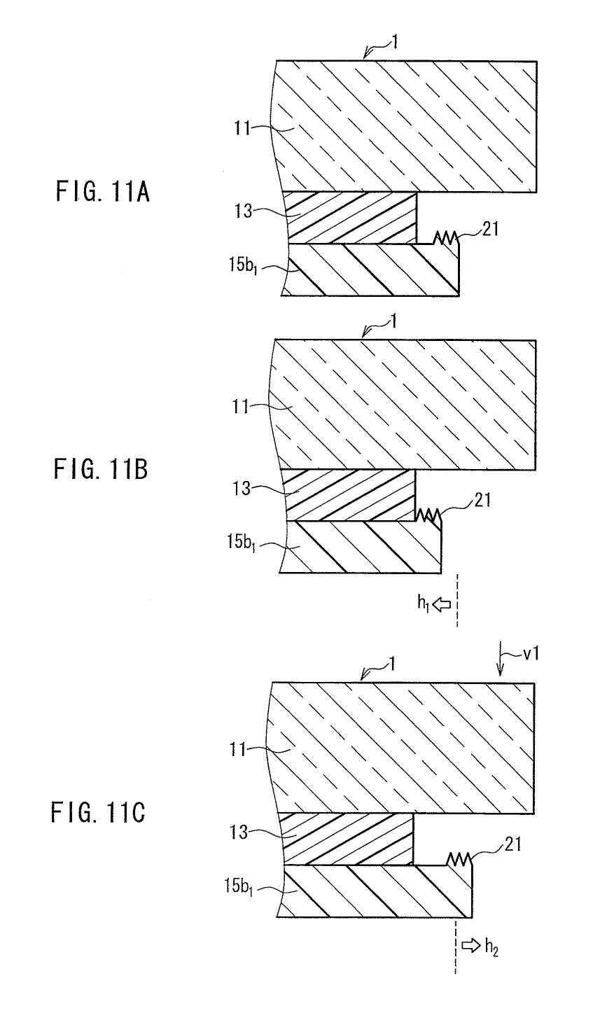

FIGS. 3A, 3B, and 3C all are cross-sectional views of the right end portion of the liquid crystal display device 1 shown in FIG. 2 (cross-sections taken along A-A′ in FIG. 4A). As shown in FIG. 3B, when the liquid crystal display device 1 is affected by temperature, humidity or the like, the polarizing plate 15b₁ shrinks in the h₁ direction similarly to the case shown in FIG. 11.

However, in the state as shown in FIG. 3A, a burr portion 21 of the polarizing plate 15b₁ is not covered with the double-sided tape 13a. Therefore, even when the polarizing plate 15b₁ shrinks due to heat or the like as shown in FIG. 3B, the influence to be imposed on the double-sided tape 13a can be decreased. Namely, formation of air bubbles can be suppressed.

Further, since the polarizing plate 15b₁ swells rightwards from the state as shown in FIG. 3B so as to fall in a state as shown in FIG. 3C, the influence to be imposed on the double-sided tape 13a can be decreased.

Namely, since the double-sided tape 13a as an adhesive layer 13 is configured small not to cover the burr portion 21 of the polarizing plate 15b₁, the influence caused by the swelling and shrinkage of the polarizing plate 15b₁ can be decreased. The degree in decreasing the size of the adhesive layer 13 may be decided with reference to the accuracy in cutting the end portion of the polarizing plate, the material of the polarizing plate, coefficients of swelling and shrinkage or the like. For example, in the present embodiment, the double-sided tape 13a is formed so that the periphery is smaller by about 0.1 to 0.5 mm than the outer edge of the polarizing plate.

As mentioned above, in the liquid crystal display device 1 of the present embodiment, generation and enlargement of air bubbles above the burr portion 21 can be suppressed, and thus degradation in the quality and the durability of the liquid crystal display device 1 can be suppressed.

[1-2. Variations]

In the above explanation, as shown in FIG. 4A, it is supposed that the double-sided tape 13a is attached to the polarizing plate 15b₁ so that the entire end portion 421 is located inside the outer edge 401 of the polarizing plate 15b₁.

However, for example as shown in FIG. 4B, the double-sided tape 13a may be arranged so that its end portion 421 is located inside the outer edge 401 of the polarizing plate 15b₁ only in the polarizing axis direction (X-direction) of the polarizing plate 15b₁. In other words, the double-sided tape 13a may be arranged so that the end part 421 of the double-sided tape 13a will be located inside the outer edge 401 of the polarizing plate that crosses the polarizing axis (X-direction).

This arrangement is employed since swelling and/or shrinkage easily occurs in the X-direction in a case where the polarizing axis (transmission axis) of the polarizing plate is in the X-direction. For this reason, similar effects can be achieved if the size of the double-sided tape 13a is decreased only in the X-direction.

In this case, since the double-sided tape 13a can be made larger in the Y-direction, the protective plate 11 and the polarizing plate 15b₁ can be adhered to each other more stably.

The protective plate 11, the double-sided tape 13a and the polarizing plate 15b₁ are shaped rectangular. It should be noted however, that the shapes are not limited to the rectangles, but they may be for example circular, elliptic or triangular as long as the double-sided tape 13a is formed so that the end portion is located inside the outer edge of the polarizing plate 15b₁ in the polarizing axis direction of the polarizing plate.

[1-3. Method for Manufacturing a Liquid Crystal Display Device]

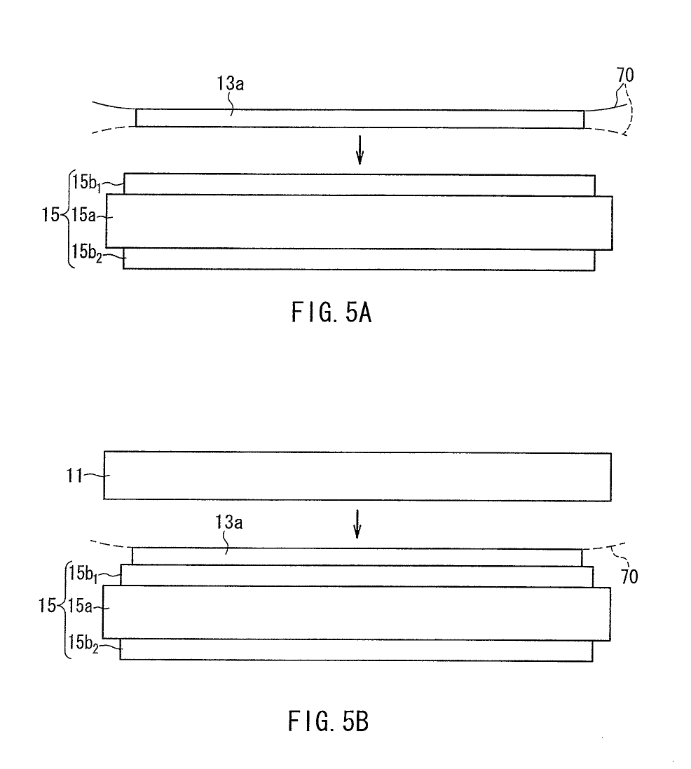

FIGS. 5A and 5B are schematic views showing a method for manufacturing the liquid crystal display device 1 shown in FIG. 2. First, a step of adhering a liquid crystal panel 15 and the lower face of the double-sided tape 13a to each other will be explained with reference to FIG. 5A.

The upper polarizing plate 15b₁ of the liquid crystal panel 15 is arranged to face the double-sided tape 13a. Since protective films 70 have been attached to the upper face and the lower face of the double-sided tape 13a, the protective film 70 on the surface facing the polarizing plate 15b₁ (the lower face of the double-sided tape 13a) is peeled off in advance.

Subsequently, the polarizing plate 15b₁ and the double-sided tape 13a are attached to each other under the atmospheric pressure environment. Since both the liquid crystal panel 15 including the polarizing plate 15b₁ and the double-sided tape 13a have deflection characteristics and a low stiffness, they can be attached to each other comparatively easily under the atmospheric pressure environment.

Next, a step of adhering the protective plate 11 and the polarizing plate 15b₁ to which the double-sided tape 13a have been attached will be explained with reference to FIG. 5B. First, the protective plate 11 is arranged to face the double-sided tape 13a attached to the polarizing plate 15b₁. Previous to the arrangement, the protective film 11 on the upper face of the double-sided tape 13a is peeled off.

Subsequently, the protective plate 11 and the upper face of the liquid crystal panel 15 to which the double-sided tape 13a has been attached are attached to each other under a vacuum environment. The liquid crystal panel 15 having the double-sided tape 13a has deflection characteristics, while the protective plate 11 has a high stiffness and less deflection characteristics, because the protective plate 11 is made of, for example, glass, an acrylic material, polycarbonate or the like. Therefore, for preventing generation of air bubbles or the like, the protective plate 11 and the liquid crystal panel 15 are attached to each other under the vacuum environment.

The above-mentioned liquid crystal display device 1 can be manufactured through the above-mentioned manufacturing steps.

### 2. Second Environment

[2-1. Structure of a Liquid Crystal Display Device]

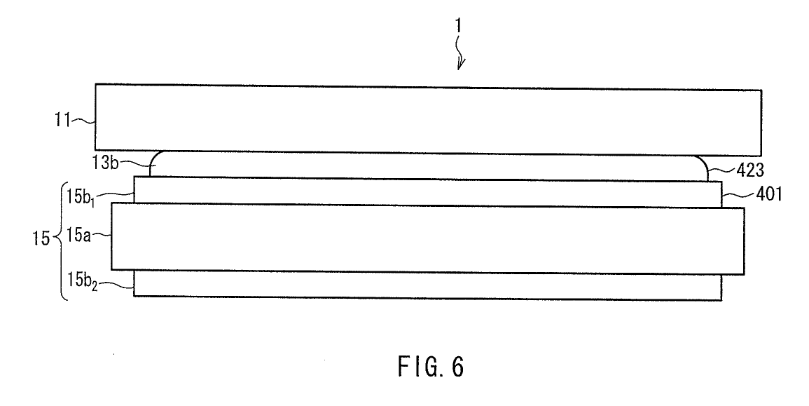

Though the double-sided tape 13a was used as the adhesive layer 13 in the above-described environment, an adhesive bond 13b may be used alternatively as shown in FIG. 6. Ultraviolet curing type resin or the like is used as the adhesive bond, for example. As a result of using the adhesive bond 13b for the adhesive layer 13, there is no necessity of fixing the positions at the time of attaching the protective plate 11 and the liquid crystal panel 15, and thus the relative positions can be controlled with a high degree of accuracy.

Even in a case of using the adhesive bond 13b, it is preferable that the adhesive bond 13b is attached to the polarizing plate 15b₁ so that the outer edge 423 of the adhesive bond 13b is located inside the outer edge 401 of the polarizing plate 15b₁. Thereby, similarly to the case of the double-sided tape 13a, degradation in the quality and the durability of the liquid crystal display device 1, which is caused by the burr portion 21 formed at the end portion of the polarizing plate 15b₁, can be suppressed.

[2-2. Method for Manufacturing a Liquid Crystal Display Device]

[2-2-1. A Case of Using a Protective Plate with a Groove]

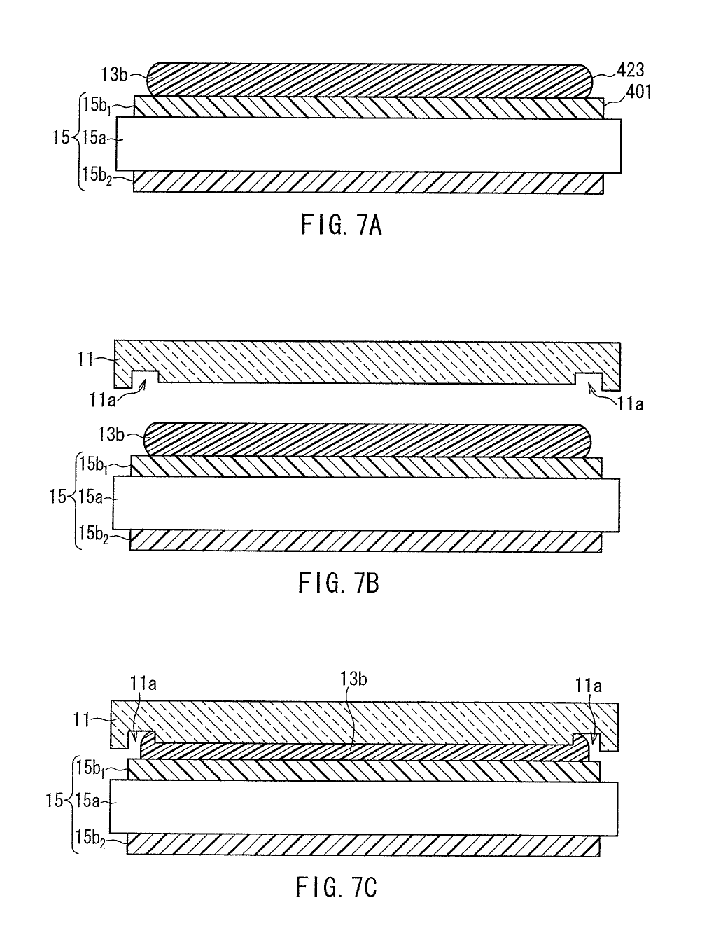

FIGS. 7A, 7B and 7C are schematic views showing a method for manufacturing a liquid crystal display device 1 using the adhesive bond 13b as shown in FIG. 6. First, a step of adhering the liquid crystal panel 15 and the lower face of the double-sided tape 13a will be explained with reference to FIG. 7A. The adhesive bond 13b is applied on the upper face of the polarizing plate 15b₁ of the liquid crystal panel 15, thereby an adhesive layer 13 is formed. At this time, the adhesive layer 13 is formed so that the outer edge 423 of the adhesive bond 13b is located inside the outer edge 401 of the polarizing plate 15b₁.

Next, a step of adhering a protective plate 11 and the polarizing plate 15b₁ on which the adhesive bond 13b has been applied will be explained with reference to FIGS. 7B and 7C. On the protective plate 11 of the present embodiment, a groove 11a is formed. The groove 11a is shaped like a frame inside the periphery of the protective plate 11 and serves to prevent the adhesive bond 13b from flowing out during pressure application to the protective plate 11. In FIGS. 7B and 7C, the groove Ha has a cross section of a substantial open box shape, but alternatively it may have a substantial U shape or substantial V shape.

This protective plate 11 is arranged to face the adhesive bond 13b applied on the polarizing plate 15b₁. Later, the protective plate 11 is applied from above with pressure so that the protective plate 11 and the upper face of the liquid crystal panel 15 having the polarizing plate 15b₁ applied with the adhesive bond 13b are attached to each other under a vacuum environment. At this time, as shown in FIG. 7C, the adhesive bond 13b spreads to the periphery of the polarizing plate 15b₁ and flows into the groove Ha.

Since the adhesive bond 13b flows into the groove 11a, the outer edge 423 of the adhesive bond 13b can be prevented from spreading to the burr portion 21 of the polarizing plate 15b₁. Therefore, generation of air bubbles, which is caused by swelling and/or shrinkage of the polarizing plate 15b₁, can be suppressed.

[2-2-2. A Case of Providing a Weir Structure]

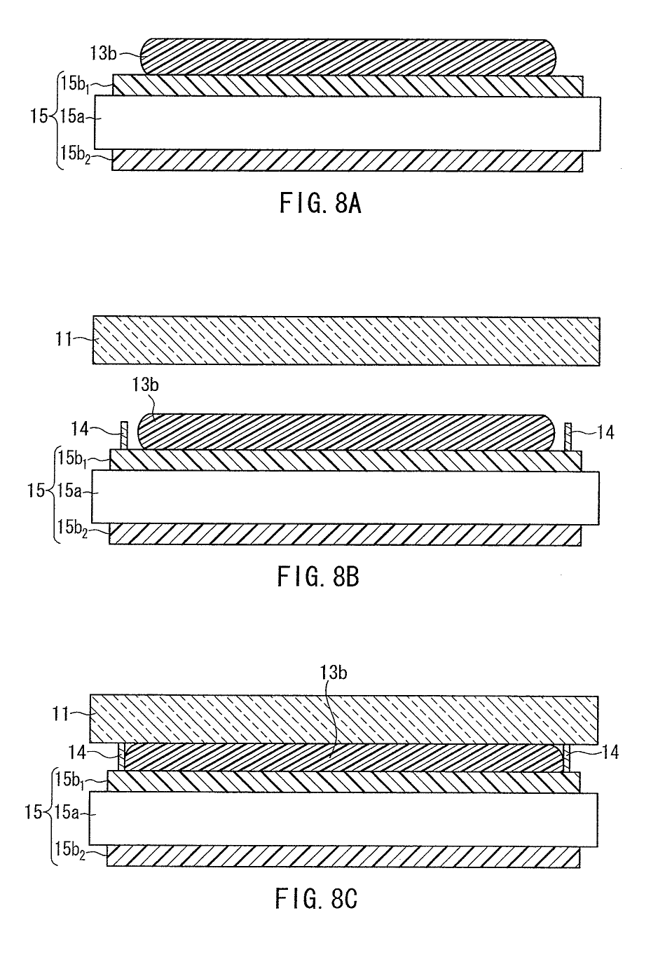

FIGS. 8A, 8B and 8C are schematic views showing a method for manufacturing a liquid crystal display device 1 using the adhesive bond 13b as shown in FIG. 6. First in FIG. 8A, similarly to the case of FIG. 7A, the adhesive bond 13b is applied on the upper face of the polarizing plate 15b₁ of the liquid crystal panel 15, thereby an adhesive layer 13 is formed.

Next, a step of adhering the protective plate 11 and the polarizing plate 15b₁ on which the adhesive bond 13b has been applied will be explained with reference to FIGS. 8B and 8C. A wall portion 14 is formed on the periphery of the adhesive layer 13 of the adhesive bond 13b according to the present embodiment. The wall portion 14 is shaped like a frame formed inside the periphery of the polarizing plate 15b₁ so as to surround the periphery of the adhesive layer 13, and its weir structure serves to stop flow-out of the adhesive bond 13b at the time of applying pressure on the protective plate 11. For example, the wall portion 14 is formed of a photosensitive resin or the like.

The protective plate 11 is arranged to face the adhesive bond 13b applied on the polarizing plate 15b₁, and subsequently the protective plate 11 is applied with pressure from above, so that the protective plate 11 and the upper face of the liquid crystal panel 15 that has been prepared by applying the adhesive bond 13b on the polarizing plate 15b₁ are attached to each other under a vacuum environment. At this time, as shown in FIG. 8C, the adhesive bond 13b spreads to the periphery of the polarizing plate 15b₁.

However, the wall portion 14 serves to prevent the outer edge 423 of the adhesive bond 13b from spreading to the burr portion 21 of the polarizing plate 15b₁. Therefore, generation of air bubbles, which is caused by swelling and/or shrinkage of the polarizing plate 15b₁, can be suppressed.

### 3. Miscellaneous

The present invention is not limited to any of the above-described embodiments for the present invention, but can be modified within the scope of the present invention.

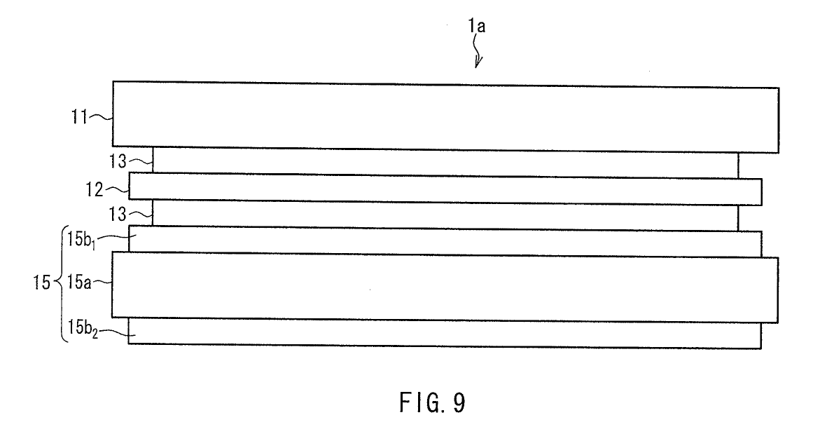

For example, the present invention can be applied to a liquid crystal display device that uses a touch panel for the transparent member. FIG. 9 shows an example of a liquid crystal display device 1a with a touch panel 12. The liquid crystal display device 1a has an adhesive layer 13 on the upper face of its liquid crystal panel 15, and the touch panel 12 as the transparent member is attached through this adhesive layer 13.

After forming another adhesive layer 13 on the upper face of the touch panel 12, a pressure is applied to attach a protective plate 11 thereto under a vacuum environment.

Similarly in this case, generation of air bubbles caused by swelling and/or shrinkage of the polarizing plate 15b₁ in the liquid crystal display device 1a can be suppressed. Thereby, it is possible to provide a liquid crystal display device with a touch panel rarely affected by the swelling/shrinkage of the polarizing plate.

Furthermore, the present invention can be applied to a liquid crystal display device prepared by attaching a plurality of liquid crystal panels. For example, in a case of attaching a switching liquid crystal panel and a display liquid crystal panel, it is required only that an adhesive layer is formed to be smaller than the polarizing plates of the respective liquid crystal panels.

### INDUSTRIAL APPLICABILITY

The present invention can be used favorably to a display device having a transparent member and also a method for manufacturing the same.

1. A display device comprising: a display panel having a polarizing plate; and a translucent member adhered to the polarizing plate through an adhesive layer,
the adhesive layer is arranged so that at least a part of an end portion of the adhesive layer is located inside the outer edge of the polarizing plate.

2. The display device according to claim 1, wherein the adhesive layer is arranged so that the end portion is located inside the outer edge of the polarizing plate in the polarizing axis direction of the polarizing plate.

3. The display device according to claim 1, wherein the adhesive layer is formed of a double-sided tape.

4. The display device according to claim 1, wherein the adhesive layer is formed of an adhesive bond.

5. A method for manufacturing a display device comprising: a display panel having a polarizing plate; and a translucent member adhered to the polarizing plate through an adhesive layer, the method comprises:
a first step of forming the adhesive layer on the polarizing plate so that at least a part of an end portion of the adhesive layer is located inside the outer edge of the polarizing plate; and
a second step of bringing the translucent member through the adhesive layer into intimate contact with the polarizing plate on which the adhesive layer has been formed in the first step.

6. The method for manufacturing a display device according to claim 5, wherein the first step is performed to form the adhesive layer so that the end portion of the adhesive layer is located inside the outer edge of the polarizing plate in the polarizing axis direction of the polarizing plate.

7. The method for manufacturing a display device according to claim 5, wherein the first step is performed under an atmospheric pressure environment and the second step is performed under a vacuum environment.
